(19) United States
(12) Patent Application Publication
(10) Pub. No.: US 2024/0110522 A1
(43) Pub. Date: Apr. 4, 2024

(54) SHAFT COUPLING FOR A GAS TURBINE ENGINE

(71) Applicant: General Electric Company, Schenectady, NY (US)

(72) Inventors: Arthur William Sibbach, Boxford, MA (US); Brandon Wayne Miller, Liberty Township, OH (US); Andrew Hudecki, Milford, OH (US)

(21) Appl. No.: 17/959,336

(22) Filed: Oct. 4, 2022

(51) Int. Cl. F02C 7/36; F16D 1/10

(52) U.S. Cl. CPC F02C 7/36; F16D 1/10; F05D 2220/323; F05D 2240/60

(57) ABSTRACT

A gas turbine engine includes a rotatably driven engine component including a shaft coupling. The shaft coupling defines a first axial centerline and includes an inner surface. The inner surface includes a plurality of internal splines extending radially inwardly from the inner surface with respect to the first axial centerline. The engine further includes a driving member having a driving end portion and defining a second axial centerline. The driving end portion includes an outer surface and a plurality of external splines extending radially outwardly from the outer surface with respect to the second axial centerline. The plurality of external splines is drivingly engaged with the plurality of internal splines. The plurality of internal splines or the plurality of external splines comprises bowed splines.

### FIELD

The present disclosure relates to a gas turbine engine and more particularly, to shaft coupling for a turbofan engine.

### BACKGROUND

Gas turbine engines, such as turbofan engines, may be used for aircraft propulsion. Turbofan engines generally include a turbine section that is mechanically coupled to a fan section. A power gearbox may be used to transfer power from the turbine section to the fan section. Relative movement may occur between the turbine section and the power gearbox.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an exemplary aircraft in accordance with an exemplary aspect of the present disclosure.

FIG. 2 is a schematic view of an exemplary gas turbine engine in accordance with an exemplary aspect of the present disclosure.

FIG. 3 is a side view of an exemplary driving member and a rotatably driven engine component as may be implemented in the gas turbine engine as shown in FIG. 2, according to exemplary embodiments of the present disclosure.

FIG. 4 is a front view of the driving member as shown in FIG. 3, according to exemplary embodiments of the present disclosure.

FIG. 5 is a front view of the exemplary shaft coupling shown in FIG. 3, according to exemplary embodiments of the present disclosure.

FIG. 6 is a side view of a portion of the driving member as shown in FIG. 3, according to exemplary embodiments of the present disclosure.

FIG. 7 is a side view of a portion of the shaft coupling as shown in FIG. 3, according to exemplary embodiments of the present disclosure.

FIG. 8 is a top view of an exemplary bowed spline according to particular embodiments of the present disclosure.

FIG. 9 is a front view of the driving member and shaft coupling as shown in FIG. 3, according to exemplary embodiments of the present disclosure.

FIG. 10 is a side view of the driving member as shown in FIG. 3, including alternate embodiments of a shaft coupling according to various embodiments of the present disclosure.

FIG. 11 is a side view of the driving member as shown in FIG. 3, including alternate embodiments of a shaft coupling according to various embodiments of the present disclosure.

Repeat use of reference characters in the present specification and drawings is intended to represent the same or analogous features or elements of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary. The singular forms “a”, “an”, and “the” include plural references unless the context clearly dictates otherwise. The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components. Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

The term “turbomachine” or “turbomachinery” refers to a machine including one or more compressors, a heat generating section (e.g., a combustion section), and one or more turbines that together generate a torque output. The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The present disclosure is generally related to a turbofan gas turbine engine. Turbofan gas turbine engines include multiple shafts which drive various rotatable engine components. There are many forces acting upon the various shafts, thus resulting in stresses at a coupling point between the driving shaft and the respective rotatably driven engine component. For example, an indirect drive or geared turbofan gas turbine engine incorporates a power gearbox between the fan and a turbine shaft such as a low-pressure turbine shaft driving the power gearbox. When an aircraft takes off, experiences turbulence, lands, or during other events, there may be axial and/or angular relative movement between the power gearbox and the low-pressure turbine shaft, thus resulting in stress on the gears and/or the coupling point between the power gearbox and the low-pressure turbine shaft. In order to relieve the stress on the gears of the power gearbox and/or the coupling point between the power gearbox and the low-pressure turbine shaft, some portion of the system must be flexible.

This disclosure provides a coupling system that will accommodate relative axial and radial/angular movement between a driven engine component such as the power gearbox, and a driving member such as the low-pressure turbine shaft. This system may also be used with a tail-cone generator to allow flexible movement of the generator relative to a low-pressure shaft of the auxiliary power unit or gas turbine engine.

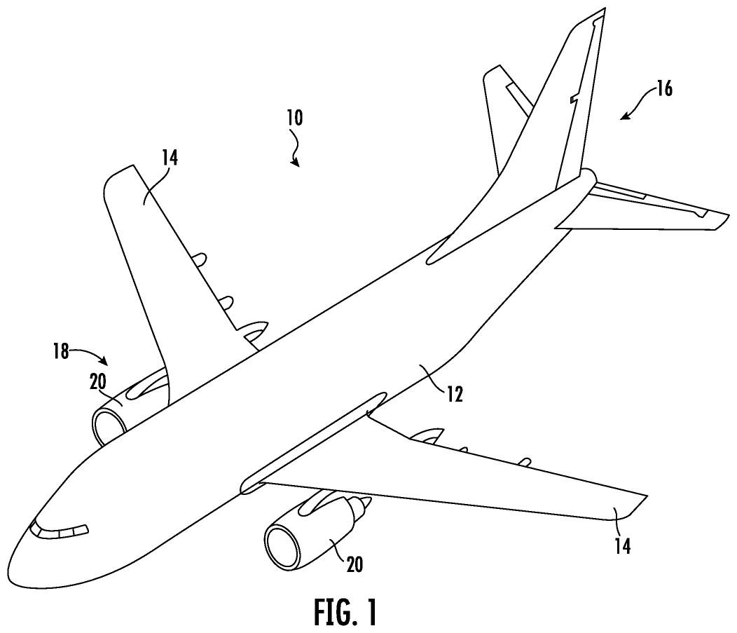

Referring now to the drawings, FIG. 1 is a perspective view of an exemplary aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing(s) 14, in other embodiments it may additionally or alternatively include one or more aspects coupled to other parts of the aircraft 10, such as, for example, the empennage 16, the fuselage 12, or both. The propulsion system 18 includes at least one engine. In the exemplary embodiment shown, the aircraft 10 includes a pair of gas turbine engines 20. Each gas turbine engine 20 is mounted to the aircraft 10 in an under-wing configuration. Each gas turbine engine 20 is capable of selectively generating a propulsive thrust for the aircraft 10. The gas turbine engines 20 may be configured to burn various forms of fuel including, but not limited to unless otherwise provided, jet fuel/aviation turbine fuel, and hydrogen fuel. In other configurations, the aircraft 10 may include an auxiliary power unit (not shown).

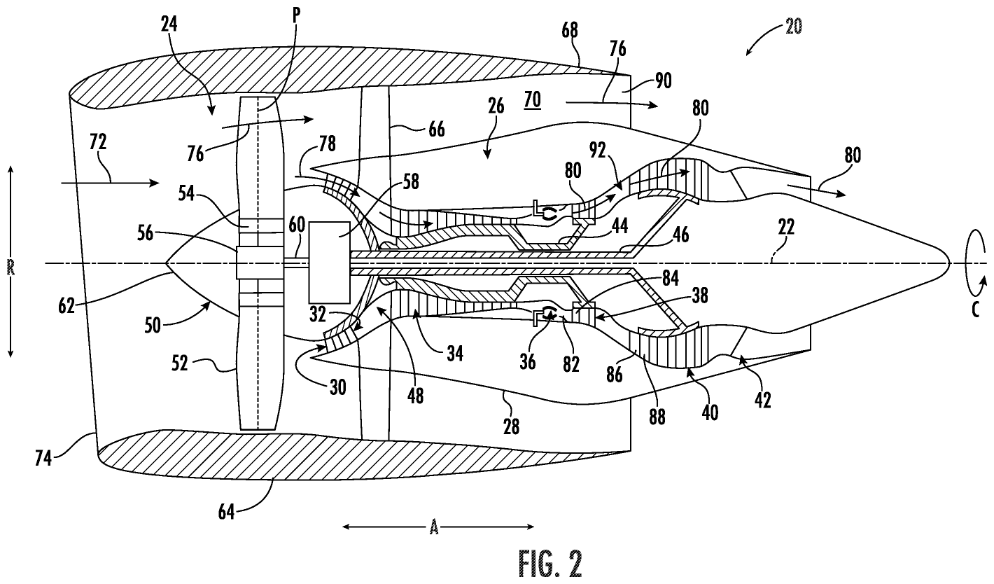

FIG. 2 is a cross-sectional side view of a gas turbine engine 20 in accordance with an exemplary embodiment of the present disclosure. More particularly, for the embodiment of FIG. 2, the gas turbine engine 20 is a multi-spool, high-bypass turbofan jet engine, sometimes also referred to as a “turbofan engine.” As shown in FIG. 2, the gas turbine engine 20 defines an axial direction A (extending parallel to a longitudinal centerline 22 provided for reference), a radial direction R, and a circumferential direction C extending about the longitudinal centerline 22. In general, the gas turbine engine 20 includes a fan section 24 and a turbomachine 26 disposed downstream from the fan section 24.

The exemplary turbomachine 26 depicted generally includes an engine casing 28 that defines an annular core inlet 30. The engine casing 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and a jet exhaust nozzle 42.

A high-pressure turbine shaft 44 drivingly connects the high-pressure turbine 38 to the high-pressure compressor 34. A low-pressure turbine shaft 46 that drivingly connects the low-pressure turbine 40 to the low-pressure compressor 32. The compressor section, combustion section 36, turbine section, and jet exhaust nozzle 42 together define a working gas flow path 48 through the gas turbine engine 20.

For the embodiment depicted, the fan section 24 includes a fan 50 having a plurality of fan blades 52 coupled to a disk 54 in a spaced apart manner. As depicted, the fan blades 52 extend outwardly from disk 54 generally along the radial direction R. Each fan blade 52 is rotatable with the disk 54 about a pitch axis P by virtue of the fan blades 52 being operatively coupled to a suitable pitch change mechanism 56 configured to collectively vary the pitch of the fan blades 52, e.g., in unison. The fan blades 52, disk 54, and pitch change mechanism 56 are together rotatable about the longitudinal centerline 22 by the low-pressure turbine shaft 46.

As shown in FIG. 2, the gas turbine engine 20 further includes a power gearbox or power gearbox 58. The power gearbox 58 includes a plurality of gears for adjusting a rotational speed of the fan 50 relative to a rotational speed of the low-pressure turbine shaft 46, such that the fan 50 and the low-pressure turbine shaft 46 may rotate at more efficient relative speeds. The power gearbox 58 may be any type of power gearbox suitable to facilitate coupling the low-pressure turbine shaft 46 to the fan 50 while allowing each of the low-pressure turbine 46 and the fan 50 to operate at a desired speed. For example, in some embodiments, the power gearbox 58 may be a reduction power gearbox. Utilizing a reduction power gearbox may enable the comparatively higher speed operation of the low-pressure turbine 46 while maintaining fan speeds sufficient to provide for increased air bypass ratios, thereby allowing for efficient operation of the gas turbine engine 20. Moreover, utilizing a reduction power gearbox may allow for a reduction in turbine stages that would otherwise be present (e.g., in direct drive engine configurations), thereby providing a reduction in weight and complexity of the engine.

Referring still to the exemplary embodiment of FIG. 2, the disk 54 is connected to the power gearbox 58 via a fan shaft 60. The disk 54 is covered by rotatable front hub 62 of the fan section 24 (sometimes also referred to as a “spinner”). The front hub 62 is aerodynamically contoured to promote an airflow through the plurality of fan blades 52. Additionally, the exemplary fan section 24 includes an annular fan casing or outer nacelle 64 that circumferentially surrounds the fan 50 and/or at least a portion of the turbomachine 26. The nacelle 64 is supported relative to the turbomachine 26 by a plurality of circumferentially spaced struts or outlet guide vanes 66 in the embodiment depicted. Moreover, a downstream section 68 of the nacelle 64 extends over an outer portion of the turbomachine 26 to define a bypass airflow passage 70 therebetween.

It should be appreciated, however, that the exemplary gas turbine engine 20 depicted in FIG. 2 is provided by way of example only, and that in other exemplary embodiments, the gas turbine engine 20 may have other configurations. For example, although the gas turbine engine 20 depicted is configured as a ducted gas turbine engine (i.e., including the outer nacelle 64), in other embodiments, the gas turbine engine 20 may be an unducted or non-ducted gas turbine engine (such that the fan 50 is an unducted fan, and the outlet guide vanes 66 are cantilevered from the engine casing 28).

Additionally, or alternatively, although the gas turbine engine 20 depicted is configured as a variable pitch gas turbine engine (i.e., including a fan 50 configured as a variable pitch fan), in other embodiments, the gas turbine engine 20 may be configured as a fixed pitch gas turbine engine (such that the fan 50 includes fan blades 52 that are not rotatable about a pitch axis P). It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, a three-stream gas turbine engine, a three-spool gas turbine engine, or a turbojet gas turbine engine.

During operation of the gas turbine engine 20, a volume of air 72 enters the gas turbine engine 20 through an associated inlet 74 of the nacelle 64 and fan section 24. As the volume of air 72 passes across the fan blades 52, a first portion of air 76 is directed or routed into the bypass airflow passage 70 and a second portion of air 78 is directed or routed into the working gas flow path 48, or more specifically into the low-pressure compressor 32. The ratio between the first portion of air 76 and the second portion of air 78 is commonly known as a bypass ratio. Pressure of the second portion of air 78 is then increased as it is routed through the low-pressure compressor 32, the high-pressure compressor 34, and into the combustion section 36, where it is mixed with fuel and burned to provide combustion gases 80.

The combustion gases 80 are routed through the high-pressure turbine 38 where a portion of thermal and/or kinetic energy from the combustion gases 80 is extracted via sequential stages of high-pressure turbine stator vanes 82 that are coupled to a turbine casing and high-pressure turbine rotor blades 84 that are coupled to the high-pressure turbine shaft 44, thus causing the high-pressure turbine shaft 44 to rotate, thereby supporting operation of the high-pressure compressor 34. The combustion gases 80 are then routed through the low-pressure turbine 40 where a second portion of thermal and kinetic energy is extracted from the combustion gases 80 via sequential stages of low-pressure turbine stator vanes 86 that are coupled to a turbine casing and low-pressure turbine rotor blades 88 that are coupled to the low-pressure turbine shaft 46, thus causing the low-pressure turbine shaft 46 to rotate, thereby supporting operation of the low-pressure compressor 32 and/or rotation of the fan 50.

The combustion gases 80 are subsequently routed through the jet exhaust nozzle 42 of the turbomachine 26 to provide propulsive thrust. Simultaneously, the pressure of the first portion of air 76 is substantially increased as it is routed through the bypass airflow passage 70 before it is exhausted from a fan nozzle exhaust section 90 of the gas turbine engine 20, also providing propulsive thrust. The high-pressure turbine 38, the low-pressure turbine 40, and the nozzle exhaust section 42 at least partially define a hot gas path 92 for routing the combustion gases 80 through the turbomachine 26.

As previously presented, during operation there are many forces acting upon the various shafts and engine components, thus resulting in stresses at coupling points between the driving shafts and the respective rotatably driven engine components, particularly during takeoff, turbulence, and landing. This disclosure provides a coupling system that will accommodate relative axial and radial/angular movement between a rotatably driven engine component such as the power gearbox, and a driving member such as a turbine shaft or more particularly, the low-pressure turbine shaft 46.

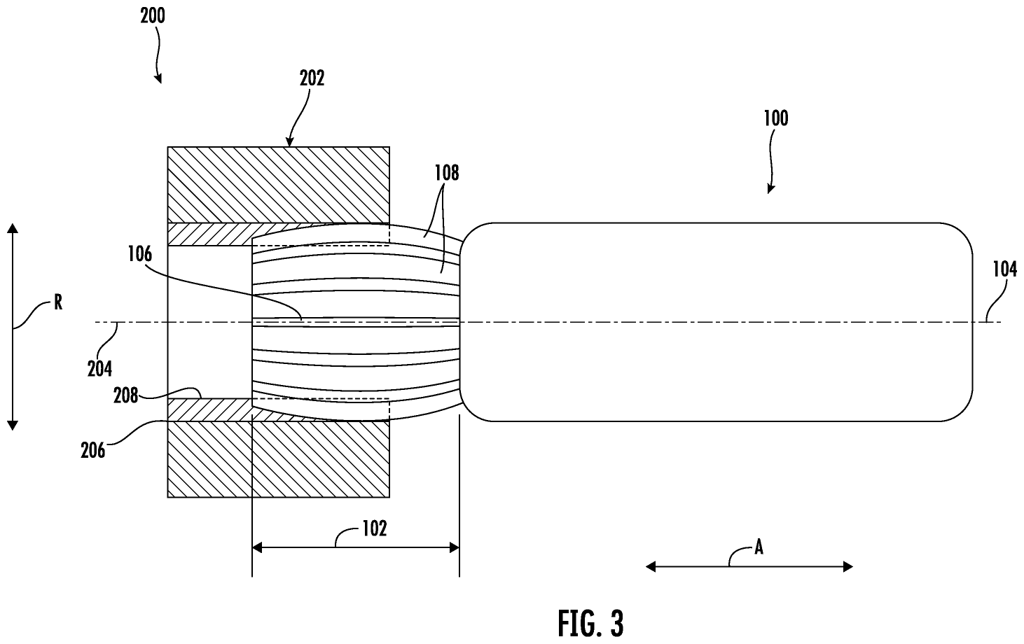

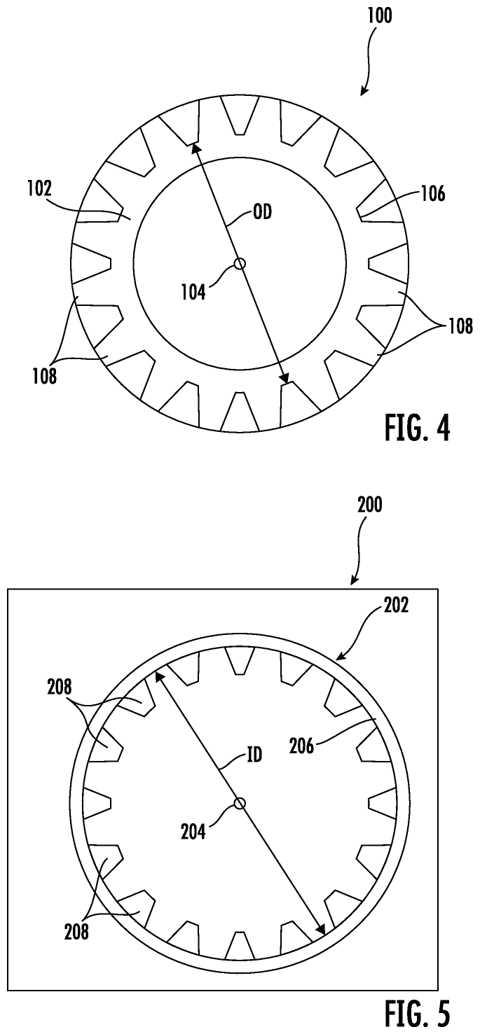

FIG. 3 is a side view of an exemplary driving member 100 and a rotatably driven engine component 200 as may be implemented in the gas turbine engine 20 as shown in FIG. 2, according to exemplary embodiments of the present disclosure. FIG. 4 is a front view of the driving member 100 as shown in FIG. 3 according to exemplary embodiments of the present disclosure. As shown in FIGS. 3 and 4, the driving member 100 includes a driving end portion 102 and defines an axial centerline 104. The driving end portion 102 includes an outer surface 106 including a plurality of external splines 108. The external splines 108 of the plurality of external splines 108 are circumferentially spaced about the outer surface 106 of the driving member 100 and extend radially outwardly in radial direction R from the outer surface 106 with respect to the axial centerline 104. In exemplary embodiments, as shown in FIG. 4, the outer surface 106 of the driving end portion 102 of the driving member 100 has a constant outer diameter OD along the axial centerline 104.

As shown in FIG. 3, the rotatably driven engine component 200 includes a shaft coupling 202. FIG. 5 provides a front view of the exemplary shaft coupling 202 shown in FIG. 3, according to exemplary embodiments of the present disclosure. As shown in FIGS. 3 and 5, the shaft coupling 202 defines an axial centerline 204 and includes an inner surface 206. The inner surface 206 includes a plurality of internal splines 208. The internal splines 208 of the plurality of internal splines 208 are circumferentially spaced along the inner surface 206 of the shaft coupling 202 and extend radially inwardly from the inner surface 206 with respect to radial direction R and with respect to the axial centerline 204.

In exemplary embodiments, as shown in FIG. 5, the inner surface 206 of the shaft coupling 202 of the rotatably driven engine component 200 has a constant inner diameter ID along the axial centerline 204. With reference to FIGS. 3, 4, and 5 it is to be appreciated that the driving end portion 102 of driving member 100 and the shaft coupling 202 of the rotatably driven engine component 200 may include any number of external splines 108 and internal splines 208 and the disclosure is not limited to the number of external splines 108 and internal splines 208 illustrated herein. In operation, as shown in FIG. 3, the plurality of external splines 108 of the driving member 100 is drivingly engaged with the plurality of internal splines 208 of the shaft coupling 202 so as to transfer toque from the driving member 100 to the rotatably driven engine component 200.

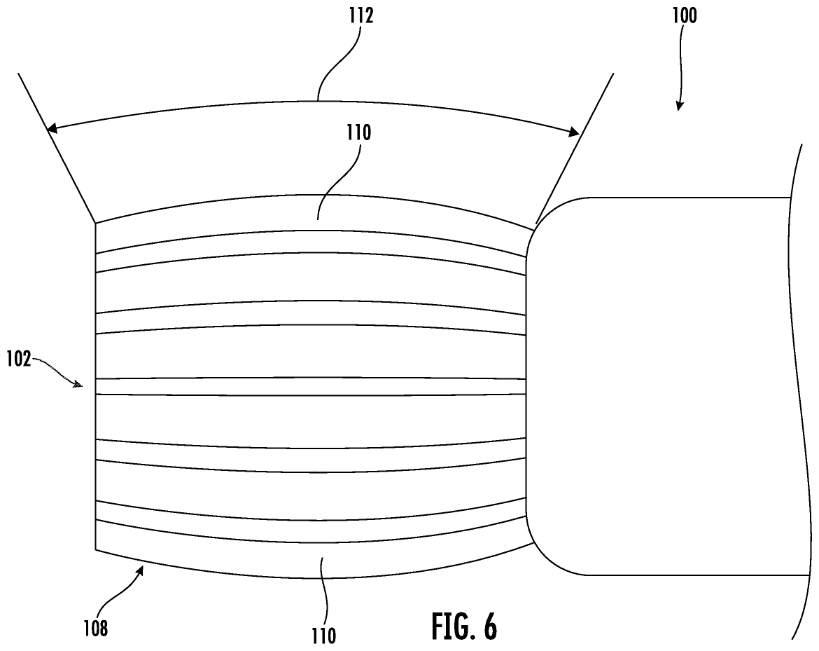

FIG. 6 is a side view of a portion of the driving member 100 including the driving end portion 102. In particular embodiments, the plurality of external splines 108 comprises spherical or bowed splines 110. As used herein the term “bowed spline” refers to a spline that is radially curved and has a continuous curve as it extends in the axial direction A along a respective axial centerline. As such, the bowed spline will have an increasing radius, a maximum radius, and a decreasing radius as the bowed spline extends in the axial direction A along the respective axial centerline. In particular embodiments, as shown in FIG. 6, the bowed splines 110 have a spherical arc 112 between one degree and ten degrees.

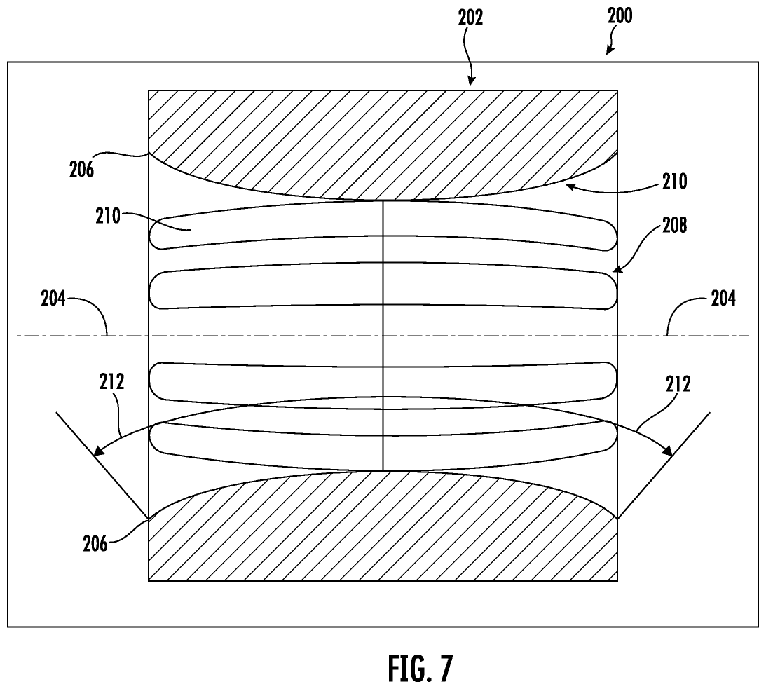

FIG. 7 is a sectioned side view of a portion of the shaft coupling 202 of the rotatably driven engine component 200 according to exemplary embodiments of the present disclosure. In particular embodiments, the plurality of internal splines 208 comprises bowed splines 210. In particular embodiments, as shown in FIG. 7, the bowed splines 210 have a spherical arc 212 between one degree and ten degrees.

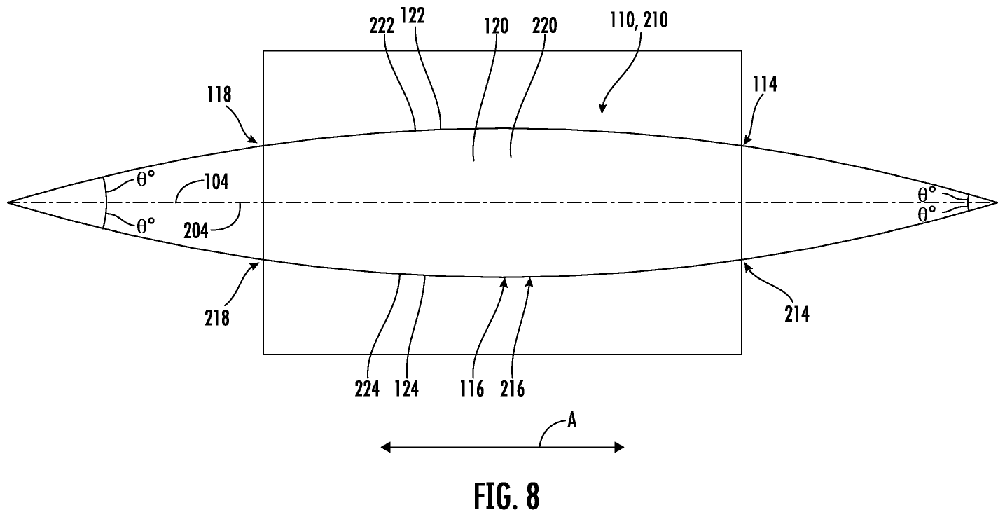

FIG. 8 is a top view of an exemplary bowed spline according to particular embodiments of the present disclosure and may be representative of either the bowed spline 110 of the plurality of external splines 108 as shown in FIG. 6 or the bowed spline 210 of the plurality of internal splines 208 as shown in FIG. 7. As shown in FIG. 8, each bowed spline 110, 210 includes a first end portion 114, 214, a middle portion 116, 216, a second end portion 118, 218, an outer wall 120, 220, and a pair of circumferentially spaced side walls 122, 222 and 124, 224 that extend from the first end portion 114, 214 to the second end portion 118, 218. In exemplary embodiments, the pair of side walls 122, 222 and 124, 224 of each bowed spline 110, 210 is tapered or converging circumferentially inwardly at the first end portion 114, 214 and at the second end portion 118, 218.

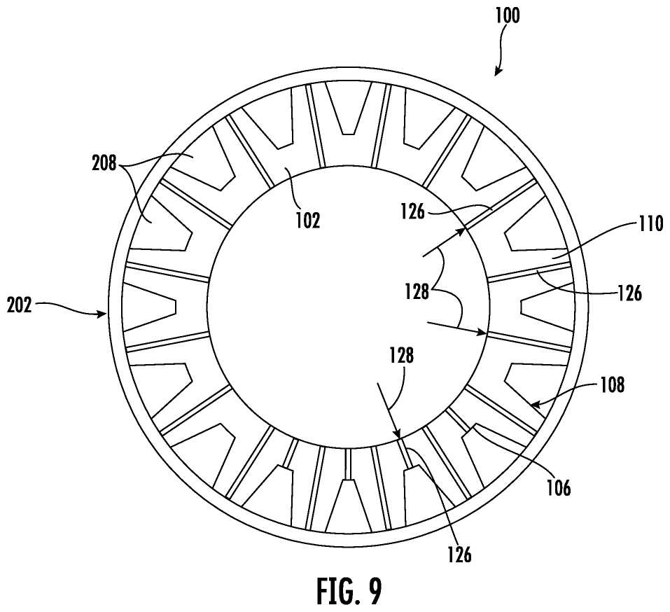

FIG. 9 is a front view of the driving member 100 inserted into the shaft coupling 202 as shown in FIG. 3, according to exemplary embodiments of the present disclosure. In exemplary embodiments, as shown in FIG. 9, one or more of the external splines 108 of the plurality of external splines 108 and/or one or more of the bowed splines 110 includes a lubricant channel 126. In addition or in the alternative, one or more of the lubricant channels 126 may extend through the outer surface 106 of the driving end portion 102 of the driving member 100. In operation, the one or more lubricant channels 126 provide a flow path for injecting a lubricant 128 from a lubricant source (not shown) through the respective external spline 108, bowed spline 110, or the outer surface 106 of the driving end portion 102 and between the plurality of external splines 108 or bowed splines 110 and the plurality of internal splines 208 to provide cooling to the driving end portion 102 of the driving member 100 and to the shaft coupling 202 of the rotatably driven engine component 200 (shown in FIG. 7).

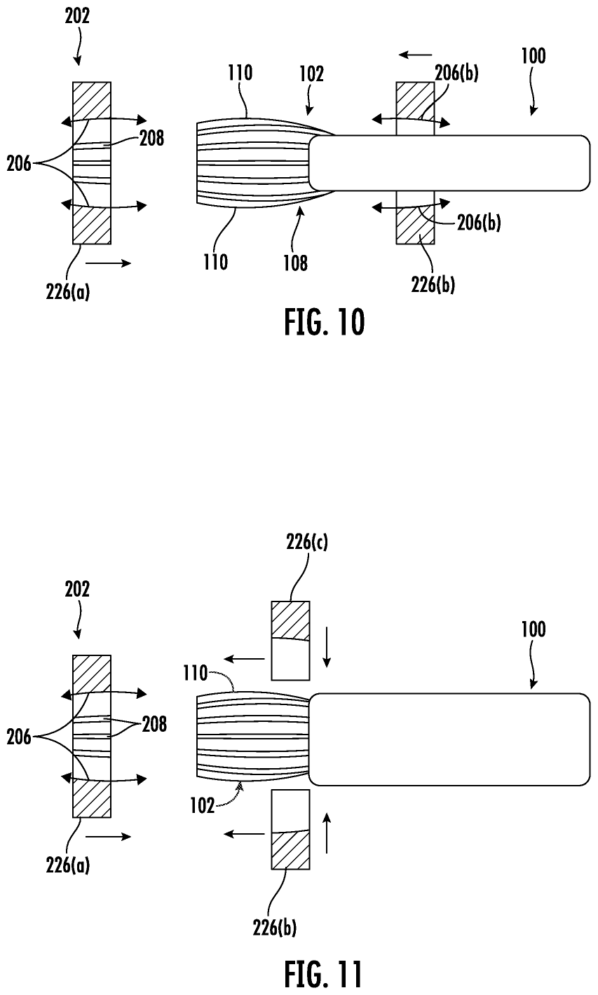

FIGS. 10 and 11 provide side views of the driving member 100 and alternate embodiments of the shaft coupling 202 according to various embodiments of the present disclosure. In particular embodiments, as shown in FIGS. 10 and 11, the inner surface 206 and the shape or form of the plurality of internal splines 208 of the shaft coupling 202 are spherical or complementary to the bowed splines 110 of the driving end portion 102 of the driving member 100. In these embodiments, the shaft coupling 202 is formed from two or more sleeves or collars. For example, in particular embodiments, as shown in FIG. 10, the shaft coupling 202 may be formed from two annular collars 226(a) and 226(b). In certain embodiments, wherein the driving member 100 is smaller than the driving end portion 102, particularly smaller than the bowed splines 110, collar 226(b) may be slid over the driving member 100 before being joined to collar 226(a). Connecting the two collars 226(a) and 226(b) will lock the driving end portion 102 of the driving member 100 into the shaft coupling 202.

In other embodiments wherein the driving member 100 is the same diameter or is larger than the driven end portion 102 as shown in FIG. 0.11, the shaft coupling 202 may be formed from collar 226(a), collar 226(b) and collar 226(c). In this configuration, collar 226(b) and collar 226(c) may be pieced together around the bowed splines 110 of the driving end portion 102 of the driving member 100. Connecting the three collars 226(a), 226(b) and 226(c) will lock the driving end portion 102 of the driving member 100 into the shaft coupling 202.

Referring now to the gas turbine engine 20 shown in FIG. 2 and to the various embodiments shown in FIGS. 3 through 11, during operation of the gas turbine engine 20, the driving member 100 and/or the shaft coupling 202 and the bowed splines 110, 210 will accommodate for relative axial movement and relative radial/angular displacement between the driving member 100 and the rotatably driven engine component 200. In particular embodiments, wherein the rotatably driven engine component 200 is the power gearbox 58 and driving member 100 is a turbine shaft such as the low-pressure turbine shaft 46, the bowed splines 110 and/or bowed splines 210 will relieve stress on the gears as the power gearbox 58 and the low-pressure turbine shaft 46 move relative to each other, thus reducing the chance of cracking or damage to power gearbox 58.

Further aspects are provided by the subject matter of the following clauses:

A gas turbine engine, comprising: a rotatably driven engine component including a shaft coupling, the shaft coupling defining a first axial centerline and including an inner surface, wherein the inner surface includes a plurality of internal splines extending radially inwardly from the inner surface with respect to the first axial centerline; and a driving member having a driving end portion and defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.

The gas turbine of the preceding clause, wherein the plurality of external splines comprises bowed splines.

The gas turbine of any preceding clause, wherein the outer surface of the driving end portion of the driving member has a constant diameter, and wherein the bowed splines have an increasing radius and a decreasing radius with respect to the axial centerline of the driving member.

The gas turbine engine of any preceding clause, wherein the bowed splines have a spherical arc between one degree and ten degrees.

The gas turbine engine of any preceding clause, wherein each bowed spline includes a first end portion, a middle portion, a second end portion, and a pair of circumferentially spaced side walls that extend from the first end portion to the second end portion, wherein the pair of circumferentially spaced side walls of each bowed spline is tapered at the first end portion and at the second end portion.

The gas turbine engine of any preceding clause, wherein one or more of the bowed splines includes a lubricant channel.

The gas turbine engine of any preceding clause, wherein the plurality of internal splines comprises bowed splines.

The gas turbine engine of any preceding clause, wherein the inner surface of the shaft coupling has a constant diameter, and wherein the bowed splines have an increasing radius and a decreasing radius with respect to the axial centerline of the shaft coupling.

The gas turbine engine of any preceding clause, wherein the bowed splines have a spherical arc between one degree and ten degrees.

The gas turbine engine of any preceding clause, wherein each bowed spline includes a first end portion, a middle portion, a second end portion, and a pair of circumferentially spaced side walls that extend from the first end portion to the second end portion, wherein the pair of side walls of each bowed spline is tapered at the first end portion and at the second end portion.

The gas turbine engine of any preceding clause, further comprising a power gearbox and a turbine shaft, wherein the driven component is the power gearbox and the driving member is the turbine shaft.

The gas turbine engine of any preceding clause, further comprising a fan section, wherein the power gearbox is coupled to the fan section.

The gas turbine engine of any preceding clause, wherein the shaft coupling comprises a plurality of internal splines that are spherical or complementary to bowed splines of the driving end portion of the driving member.

The gas turbine engine as in any preceding clause, wherein the shaft coupling is formed from two or more sleeves or collars.

The gas turbine engine as in any preceding clause, wherein the driving member 100 is the same diameter or is larger than the driven end portion 102

The gas turbine engine as in any preceding clause wherein the shaft coupling is formed from a first collar 226(a), a second collar, and a third collar.

An aircraft, comprising: a gas turbine engine, the gas turbine engine comprising; a rotatably driven engine component including a shaft coupling, the shaft coupling defining a first axial centerline and including an inner surface, wherein the inner surface includes a plurality of internal splines extending radially inwardly from the inner surface with respect to the first axial centerline; and a driving member having a driving end portion and defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.

The aircraft of the preceding clause, wherein the plurality of external splines comprises bowed splines, wherein the outer surface of the driving end portion of the driving member has a constant diameter, and wherein the bowed splines have an increasing radius and a decreasing radius with respect to the axial centerline of the driving member.

The aircraft of any preceding clause, wherein the plurality of internal splines comprises bowed splines, wherein the inner surface of the shaft coupling of the driven component has a constant diameter, and wherein the bowed splines have an increasing radius and a decreasing radius with respect to the axial centerline of the shaft coupling.

The aircraft of any preceding clause, wherein the bowed splines have a spherical arc between one degree and ten degrees.

The aircraft of any preceding clause, wherein each bowed spline includes a first end portion, a middle portion, a second end portion, and a pair of circumferentially spaced side walls that extend from the first end portion to the second end portion, wherein the pair of side walls of each bowed spline is tapered at the first end portion and at the second end portion.

The aircraft of any preceding clause, wherein at least one of the bowed splines includes a lubricant channel.

The aircraft of any preceding clause, wherein the gas turbine engine further comprises a power gearbox and a turbine shaft, wherein the driven component is the power gearbox and the driving member is the turbine shaft.

The aircraft of any preceding clause, wherein the gas turbine engine further comprises a fan section, wherein the power gearbox is coupled to the fan section.

A coupling for a gas turbine engine, comprising: a shaft coupling for a rotatably driven engine component of the gas turbine engine, the shaft coupling defining a first axial centerline and including an inner surface, wherein the inner surface includes a plurality of internal splines extending radially inwardly from the inner surface with respect to the first axial centerline; and a driving end portion for a driving member of the gas turbine engine, the driving end portion defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine, comprising:
a rotatably driven engine component including a shaft coupling, the shaft coupling defining a first axial centerline and including an inner surface, wherein the inner surface includes a plurality of internal splines extending radially inwardly from the inner surface with respect to the first axial centerline; and
a driving member having a driving end portion and defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.

2. The gas turbine engine as in claim 1, wherein the plurality of external splines comprises bowed splines.

3. The gas turbine engine as in claim 2, wherein the outer surface of the driving end portion of the driving member has a constant diameter, and wherein the bowed splines have an increasing radius and a decreasing radius with respect to the axial centerline of the driving member.

4. The gas turbine engine as in claim 2, wherein the bowed splines have a spherical arc between one degree and ten degrees.

5. The gas turbine engine as in claim 2, wherein each bowed spline includes a first end portion, a middle portion, a second end portion, and a pair of circumferentially spaced side walls that extend from the first end portion to the second end portion, wherein the pair of circumferentially spaced side walls of each bowed spline is tapered at the first end portion and at the second end portion.

6. The gas turbine engine as in claim 2, wherein one or more of the bowed splines includes a lubricant channel.

7. The gas turbine engine as in claim 1, wherein the plurality of internal splines comprises bowed splines.

8. The gas turbine engine as in claim 8, wherein the inner surface of the shaft coupling has a constant diameter, and wherein the bowed splines have an increasing radius and a decreasing radius with respect to the axial centerline of the shaft coupling.

9. The gas turbine engine as in claim 8, wherein the bowed splines have a spherical arc between one degree and ten degrees.

10. The gas turbine engine as in claim 8, wherein each bowed spline includes a first end portion, a middle portion, a second end portion, and a pair of circumferentially spaced side walls that extend from the first end portion to the second end portion, wherein the pair of side walls of each bowed spline is tapered at the first end portion and at the second end portion.

11. The gas turbine engine as in claim 1, further comprising a power gearbox and a turbine shaft, wherein the driven component is the power gearbox and the driving member is the turbine shaft.

12. The gas turbine engine as in claim 11, further comprising a fan section, wherein the power gearbox is coupled to the fan section.

13. An aircraft, comprising:
a gas turbine engine, the gas turbine engine comprising;
a rotatably driven engine component including a shaft coupling, the shaft coupling defining a first axial centerline and including an inner surface, wherein the inner surface includes a plurality of internal splines extending radially inwardly from the inner surface with respect to the first axial centerline; and
a driving member having a driving end portion and defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.

14. The aircraft as in claim 14, wherein the plurality of external splines comprises bowed splines, wherein the outer surface of the driving end portion of the driving member has a constant diameter, and wherein the bowed splines have an increasing radius and a decreasing radius with respect to the axial centerline of the driving member.

15. The aircraft as in claim 14, wherein the plurality of internal splines comprises bowed splines, wherein the inner surface of the shaft coupling of the driven component has a constant diameter, and wherein the bowed splines have an increasing radius and a decreasing radius with respect to the axial centerline of the shaft coupling.

16. The aircraft as in claim 14, wherein the bowed splines have a spherical arc between one degree and ten degrees.

17. The aircraft as in claim 14, wherein each bowed spline includes a first end portion, a middle portion, a second end portion, and a pair of circumferentially spaced side walls that extend from the first end portion to the second end portion, wherein the pair of side walls of each bowed spline is tapered at the first end portion and at the second end portion.

18. The aircraft as in claim 14, wherein at least one of the bowed splines includes a lubricant channel.

19. The aircraft as in claim 14, wherein the gas turbine engine further comprises a power gearbox and a turbine shaft, wherein the driven component is the power gearbox and the driving member is the turbine shaft.

20. A coupling for a gas turbine engine, comprising:
a shaft coupling for a rotatably driven engine component of the gas turbine engine, the shaft coupling defining a first axial centerline and including an inner surface, wherein the inner surface includes a plurality of internal splines extending radially inwardly from the inner surface with respect to the first axial centerline; and
a driving end portion for a driving member of the gas turbine engine, the driving end portion defining a second axial centerline, the driving end portion having an outer surface including a plurality of external splines extending radially outwardly from the outer surface with respect to the second axial centerline, wherein the plurality of external splines is drivingly engaged with the plurality of internal splines, and wherein the plurality of internal splines or the plurality of external splines comprises bowed splines.
